(19) United States
(12) Patent Application Publication
(10) Pub. No.: US 2009/0294562 A1
(43) Pub. Date: Dec. 3, 2009

(54) REDUNDANT TIRE AND RUBBER COMPOUND REPROCESSING

(76) Inventors: Alan Higginson, Tiverton (GB); David Higginson, Sarre (GB); Rachel Aucock, St. Felix De Villadeix (FR); Brete C. Harrison, Sonoma, CA (US)

Correspondence Address: WILSON, SONSINI, GOODRICH & ROSATI, 650 PAGE MILL ROAD, PALO ALTO, CA, 94304-1050, US

(21) Appl. No.: 12/476,211

(22) Filed: Jun. 1, 2009

Related U.S. Application Data
(60) Provisional application No. 61/058,122, filed on Jun. 2, 2008.

(51) Int. Cl. B02C 23/08; B07C 5/36

(52) U.S. Cl. 241/68; 209/606

(57) ABSTRACT

The invention provides for methods, systems, and devices for processing rubber materials including rubber from tires, tubes, shoe soles, or any other rubber containing product. Characteristics of the rubber materials, such as chemical composition and/or product manufacturer, model, and manufacture date, can be identified. Identification can be performed by personnel, can be automated, or can be a combination thereof. The characteristics of the rubber material can be used to sort the rubber product. Rubber materials suitable for a particular end product can be selected for further processing, which can include size reduction, material separation, chemical and physical processes, devulcanization, or a combination thereof. Processed rubber materials can be stored or delivered to a user or manufacturing site with product specifications.

### CROSS-REFERENCE

This application claims the benefit of priority to U.S. Provisional Application No. 61/058,122, filed Jun. 2, 2008, which is incorporated by reference herein in its entirety.

### BACKGROUND OF THE INVENTION

Automotive tires and other rubber products are often difficult to dispose. Further, many recycling procedures have been proposed or are in use to handle these rubber materials. However, most of these procedures provide an end product that is lower in quality than the original rubber material. As such, much of the recycled rubber is used for alternative uses, such as playground floors, running tracks, and various padding or rubber structures or devices.

It would be a significant advance in the art if a recycling process for waste rubber, such as old automotive tires, provided an end product having a defined composition and capable of being used to manufacture new products demanding very good rubber quality. For example, it is desirable in the art to develop a process that can recycle used automotive tires for the partial manufacture of new automotive tires. The objective of delivering high quality rubber end products from recycled rubber has proven difficult, however, the processes described herein provide a novel approach to manufacturing high quality products from recycled rubber.

### SUMMARY OF THE INVENTION

The invention provides for methods, systems, and devices for processing rubber materials including rubber from tires, tubes, shoe soles, or any other rubber containing product. Characteristics of the rubber materials, such as chemical composition and/or product manufacturer, model, and manufacture date, can be identified. Identification can be performed by personnel, can be automated, or can be a combination thereof. The characteristics of the rubber material can be used to sort the rubber product. Rubber materials suitable for a particular end product can be selected for further processing, which can include size reduction, material separation, chemical and physical processes, devulcanization, or a combination thereof. Processed rubber materials can be stored or delivered to a user or manufacturing site with product specifications.

The personnel for identifying the input materials and/or overseeing the process can be trained to follow regulatory standards and/or any other standards. The personnel can be trained to identify the composition of the input material using any of a number of analytical techniques. The analytical techniques can be any analytical technique known to one skilled in the art.

The rubber materials can be processed such that contaminants, toxic materials, metal, or any other undesirable material is removed. The rubber materials can be processed such that the processed rubber product can be used in a selected process or for a selected product. In some embodiments of the invention, the rubber is processed such that the product will meet selected specifications. These specifications can include size, composition, mechanical properties, or any other characteristic described herein.

Equipment used to process the rubber materials can include rotary shears, conveyors, troughed out feed conveyors, dividing chutes, dividing conveyors, pre-shredders, magnetic tables, granulators, overband magnets, elevating conveyors, zig zags, cyclones, grids, and meshes. Other equipment used to process the rubber materials, described herein or known to one skilled in the art, can be used to process rubber materials.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 demonstrates assessment and selection procedures for manufacturing new products from recycled rubber.

FIGS. 2A, 2B, 2C, and 2D demonstrate an exemplary system wherein after raw material, such as waste or redundant rubber, is selected by a process of the invention carried out by trained personnel, the specified raw material is delivered and loaded for a first shredding process. The bottom of FIG. 2A continues at the top of FIG. 2B. The bottom of FIG. 2B continues at the top of FIG. 2C. The bottom of FIG. 2C continues at the top of FIG. 2D.

### DETAILED DESCRIPTION OF THE INVENTION

Methods and processes are described herein that are useful in generating objects from redundant or recycled rubber, such as material to be substituted for new rubber and/or used in the manufacture of tires. In an aspect, a process comprises: assessing redundant tires and/or waste rubber materials according to a compound formulae of the waste materials; and selecting materials to be separated from the waste materials, wherein the material is selected for the manufacture of an object; and separating the selected tires and/or waste rubber materials, wherein said separation is for processing the separated material for the particular end uses predetermined for the specific qualities of the selected redundant tires.

The processes and systems described herein may require significantly less energy, such as heat energy, cooling, and the addition of chemicals to generate a recycled rubber material than current methods of rubber recycling. In an embodiment, the processes and systems can reduce a carbon footprint and improve the sustainability of a rubber recycling method.

In an embodiment, after the waste materials have been assessed, selected and separated, two types of waste materials or more may be mixed to achieve an end product formula according to an end user. In a further embodiment, the mixing can be monitored within the controls incorporated within the process to regulate and manage the end product production.

### Personnel

In an embodiment, persons carrying out the duties of assessment and selection must have completed a training course that qualifies the operatives to be fully aware of the methods and process of selection. The persons may also be aware of the adverse consequences of non compliance with laid down selection procedures. Additional process security can be carried out by inspectors exercising continuous audit of the selection procedures through sample inspections.

The assessment and selection process may be carried out in any work suitable location so long as the selected products cannot then be interfered with prior to processing the products or materials carried out in the controlled environment within the process plant. In an embodiment, the suitable location is approved by a person with training in a process of the invention.

In an embodiment, a properly trained person performs the assessment and selection functions for quality control of the selection of the redundant materials. In another embodiment, the functions are performed by computer system based on criteria or input from a user. The process may have ISO process adherence. Personnel for performing functions described herein or for controlling a computer system for performing the functions can be trained, tested, and repeatedly examined to assure high quality control of the process that can often be important to many of the processes described herein. Personnel can also be provided consistent updates based on product details or changes in products.

In an exemplary embodiment, personnel for carrying out a process or selection process of the invention are trained to assess the redundant, recycled, or waste material based on a plurality of characteristics of the material. For example, the characteristics can include, but are not limited to, material type (for example, make and size), extraction of metal, wire or fiber from the material, process size and granule type for a specific end application of the processed material, mixes of different characteristic process materials for an end application, and process volume and weight. After the initial assessment, all processes necessary to generate a new product or end application can be monitored by personnel or a computer system for the date and time of the process, the volume of the processed material, or any other item that may be desired regarding the characteristics of the final processed material for use in an end application.

### Input Materials and Identification

From the time that the redundant tire and rubber compound materials come into the control of the process regulations, the selected batches and the material that proves not fit for process can be polarized with traceable tags that move with the batches through the process system until the end product is packed ready for use or shipment. In an embodiment, all of the end products carry clear and concise traceability tags with the constituent make-up formulae labels to describe the content, for example, the end products may be bar coded or have an RFID. As a result of a recycling process providing a clear definition of the end product composition, the end products may be recycled again and repeatedly. For example, tracked recycled materials can be known and understood for the end use applications for which the materials are suited, which may also avoid or minimize material failure and health and safety issues. In another example, a process may require the identification of the composition of every tire manufactured for recycling to more easily and accurately control. A rubber material can be composed of a variety of components, including isoprene, sulfur, ebonite, 3-methylisoprene (2,3-dimethyl-1,3-butadiene), thiokol, divinylacetylene, neoprene, isobutylene (2-methylpropene), styrene butadiene rubber (SBR), acrylonitrile-butadiene rubber (NBR), cis-1,2-polyisoprene, cis-1,4-polybutadiene, polyurethane, ethylene-propylene terpolymer rubber (EPDM), metal, steel, pigment, and carbon black. Additional components can be found in U.S. Pat. Nos. 4,240,587, 5,157,176, 5,236,992, 5,375,775, 5,634,599, 5,883,139, 6,407,180, and 6,752,940, each of which are incorporated herein by reference in their entirety. Table I lists a variety of components that can be identified in various rubber compositions. Table II lists a variety of components that can be identified in redundant tires used for trucks and passenger cars in the European Union and Tire rubber from Canada. Approximately 80% of the weight of car tires and 75% of truck tires can be rubber compound. In some instances, the compositions of tires produced by different manufacturers can be similar or dissimilar. Tires can contain approximately 1.5% by weight of hazardous waste compounds, as shown in Table III. These compounds can be encased in the rubber compound or present as an alloying element. Any of these components can be identified by personnel or by automated processes and used to identify a rubber material to be processed, to identify a selected end product, used to separate the rubber material during processing, or used as a criteria for separation of the rubber material during processing.

TABLE I

| Composition A: | Composition B: | Composition C: |
|---|---|---|
| SBR Rubber | EPDM Rubber | SBR Rubber |
| SBR | EPDM | SBR 1712 |
| N-330 Carbon | N-330 Carbon | CIS-1,4 BR |
| Black | Black | |
| Sundex 790 | Plasticizing | Carbon Black |
| | Agent | |
| Plasticizing | Flexon 766 | Oil (Sundex 790) |
| Agent | | |
| Zinc Oxide | Zinc Oxide | Zinc Oxide |
| Stearic Oxide | Stearic Oxide | Sunproof Improved |
| | | Stabilizer |
| Antioxidant | Antioxidant | Wingstay 100 |
| Santocure | Santocure | Stearic Acid |
| TMTD | TMTD | N-cyclohexyl-2- |
| | | benzothiazolesulfenamide |
| Sulfur | Sulfur | 2-mercaptobenzothiazole |
| | | Sulfur |

TABLE II

| | Car Tires | Truck Tires | Tire Rubber |
|---|---|---|---|
| Material | (EU) | (EU) | (Canada) |
| Rubber/elastomers | 47% | 45% | 62% |
| Carbon black | 21.5% | 22% | 31% |
| Metal | 16.5% | 25% | NA |
| Fibre | 5.5% | — | NA |
| Zinc oxide | 1% | 2% | 2% |
| Sulfur | 1% | 1% | 1% |
| Additives | 7.5% | 5% | 4% |

TABLE III

| Chemical Name | Remarks | Content |
|---|---|---|
| Copper compounds | Alloying constituent of | Approximately 0.02% |
| | metallic reinforcing | |
| | material | |
| Zinc compounds | Zinc oxide, retained | Approximately 1% |
| | in the rubber matrix | |
| Cadmium | On trace levels, as | Maximum 0.001% |
| | cadmium compounds | |
| | attendant substance | |
| | of the zinc oxide | |
| Lead or Lead | On trace levels, as | Maximum 0.005% |
| compounds | attendant substance of | |
| | the zinc oxide | |
| Acidic solutions | Stearic acid, in solid | Approximately 0.3% |
| or acids in | form | |
| solid form | | |
| Organohalogen | Halogen butyl rubber | Maximum 0.1% |
| compounds | (tendency: decreasing) | |

Rubber materials that can also be sorted based on characteristics of how the rubber material was manufactured or the type of environment the rubber material has been exposed to. For example, a heat-cured rubber material may be sorted into a different group as a rubber material that was not heat-cured. As another example, a tire that has been exposed to high temperature fluctuations and/or UV exposure, such as in a desert, may be sorted differently from a tire that has been exposed to a temperate climate and/or low UV exposure. Alternatively, a rubber material can be sorted based on its content of or exposure to toxic or hazardous materials, such as toxic radioactive materials, toxic chemicals, or hazardous waste compounds.

In an embodiment, an assessment process technique is based upon visual examination of a rubber material, such as a tire or other materials, for selection and batching. For example, visual examination of a rubber material provide for information regarding the manufacturer, manufacture date, or product model. Visual examination can provide for a simplified method for sorting rubber products that have similar or substantially the same composition. Further analysis can be performed to identify the components of these materials that are identified as having similar or substantially the same composition. In some embodiments of the invention, visual examination is not required to identify the manufacturer, manufacture date, or product model. This information can be obtained through other methods, systems, and devices, including automated recognition, described herein.

In another embodiment, a process described herein can lead to electronic or automated recognition of different batches or end products. In some embodiments of the invention, automated systems utilizing optical, magnetic-based, and/or mechanical analysis can be used to characterize a rubber material. For example, a rubber material can be examined using a spectrophotometric method that identifies one or more components of the rubber material. Alternatively, a digital image of the rubber material is obtained and processed to determine the manufacturer or information regarding the rubber material.

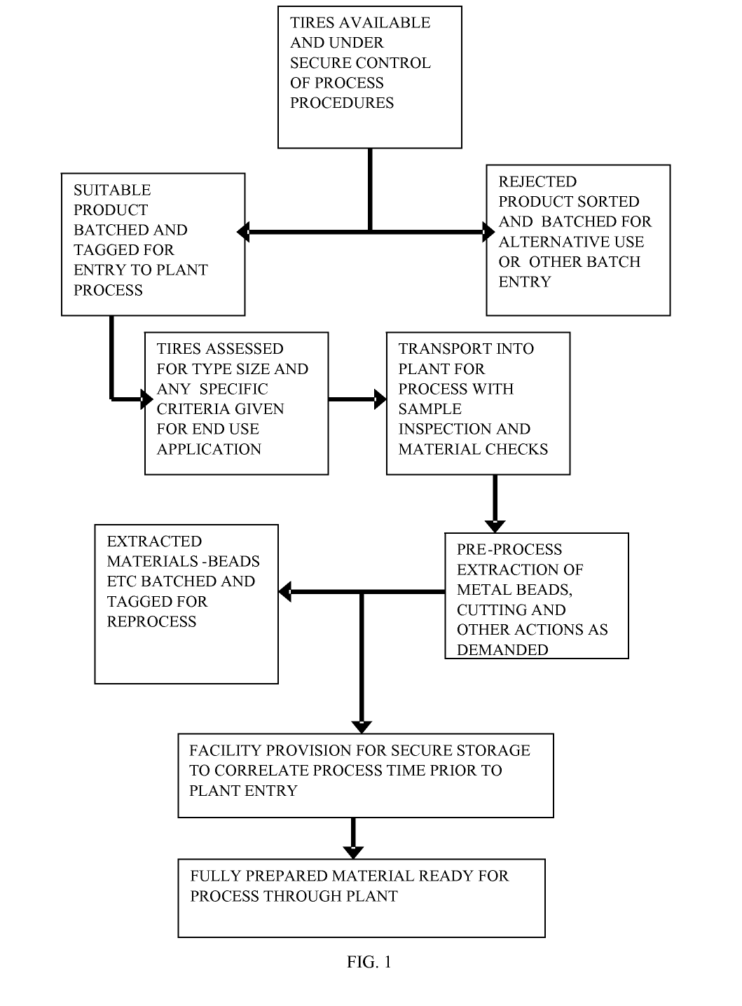

FIG. 1 demonstrates assessment and selection procedures for manufacturing new products from recycled rubber. For example, old or used tires can be made available to the selection procedures under a quality control system. For example, the control system can be manual control by trained professionals, or the control system can be automated and under computer control. In an embodiment, a tire can be electronically tagged or marked by an RFID, and then read by a computer system for entrance in a selection procedure of the invention. After the suitable redundant rubber is identified by a system (for example, trained personnel), it is batched and tagged for entry in a plant process, such as the plant process described herein. FIG. 1 also demonstrates a step of further assessing the rubber material in the selection procedures by type, size, or any other criteria relied upon as determined by the end use application. For example, the criteria may be different for redundant rubber that will be used in part to manufacture a new tire as compared to redundant rubber that will be used at a playground. In an embodiment, a recycled rubber end product of a process of the invention can be used to manufacture low-speed tires, such as fork-lift or bicycle tires. In another embodiment, a recycled rubber end product can be used as a source, in part, for the manufacture of high-speed tires, such as automobile tires.

### Material Sorting and Separation

FIG. 1 also demonstrates an exemplary process of transporting selected materials into the plant for sample inspection. For example, a person trained for inspecting the proper quality materials for an end use performs the sample inspection. In an embodiment, a machine programmed to identify material based on criteria provided from a user performs the sample inspection. As shown in FIG. 1, after a material has been selected to be processed, a preprocess procedure can be carried out. For example, preprocess procedures include extraction of metal beads, cutting of redundant rubber material, or other actions that may be demanded by a certain end application, as would be obvious to one skilled in the art. After the material is selected, and in an embodiment, prepared, it is processed through a plant, for example, as described herein below. Material that has not been selected can also be sorted and/or batched for alternative uses, or for preparation for an end application with different criteria. In another embodiment illustrated in FIG. 1, material extracted from the selected material, such as beads or metals, can be marked, sorted, and/or batched for other industrial processes. A facility for selecting a material can include a provision for storage as illustrated in FIG. 1. In an embodiment, the storage can correlate to time that is taken to transfer material prior to plant entry. For example, when the plant has to be decontaminated and cleaned of a previous batch throughput before a new material batch enters for process, material can be held in a secure storage area where risks of mixing with other materials can be minimized by compliance with procedures.

### Material Size Reduction

An example rubber granule preparation plant is designed to process up to 15 tons of in-feed tire of various defined quality compound per hour, including Auto, Commercial, and Truck tires to Super Singles Size 15″ to 16″ wide and further cut sizes can be dimensioned to be accommodated by the equipment for the process. A finished product size can be dependent upon final granulation grid hole diameter based upon a sizing table; for example, a supplied basic finished product granules are about ⅘ mm. In some embodiments of the invention, the finished product granules are up to about, greater than about, or about 0.01, 0.1, 0.5, 0.8, 1, 2, 4, 5, 10, 20, or 50 mm in size. The finished product can have a size that is between about 0.5 to 10 mm, 1 to 7 mm, 3 to 6 mm, or 4 to 5 mm.

During a process described herein for producing a redundant rubber product, waste or used rubber can be fed into a system or device for tearing, shearing, or shredding the waste material. In an exemplary embodiment, tires are fed into a rotary shear hopper. Other types of devices for shredding redundant or recycled rubber may vary to achieve size shape and density for process requirements because the granulate or powder products are designed for an end use application.

In an example, the rotary shear consists of two slow speed contra rotating shafts fitted with hook type knives interspaced with protective discs. Individual hydraulic motors, each fitted with a reduction gearbox, can drive the shafts. All bearings are oil filled and the machine and cases are sealed to avoid ingress of deleterious liquids. The hydraulic motors are provided with hydraulic oil from a separate self-contained power pack, complete with oil cooler and electrical controls. The unit is mounted on a self-supporting steel structure complete with in-feed hopper and discharge chute.

After the processed material leaves system or device for tearing, shearing, or shredding the waste material, the processed material can be discharged by means of a conveyor. In an example, the conveyor is a rubber chevron belt conveyor. The conveyor can be any conveyor or system as would be obvious to one skilled in the art to move processed material from one part of the process to the next.

In an embodiment, at the head of the conveyor, processed material is divided and directed onto two conveyors that carry the processed material onto at least one preshredder. A first stage preshredder can be fitted with grids having a hole size of about 50 mm in diameter, and the rotor of the preshredder may run at about 190 rpm. In other embodiments of the invention, the grids can have a hole size of up to about, greater than about, or about 10, 20, 50, 75, 100, or 150 mm in diameter. The preshredder may also be run at up to about, about, or greater than about 50, 150, 200, 250, 300, or 350 rpm. In an embodiment, a preshredder comprises a rotator with knives in a chevron formation rotating on a steel body. In the exemplary embodiment, the body can be fitted with two rows of static adjustable knives and, in high wear areas, with a wear resistance liner. In another embodiment, the first stage preshredder is fitted with a grid having a hole size of about 10-500 mm in diameter. The grid can also have a hole size that is up to about, about, or greater than about 1, 5, 10, 50, 75, 100, 200, 300, 400, 500, 750, or 1000 mm in diameter. The hole size can be between about 1 to 1000, 5 to 750, 10 to 500, 20 to 250, or 40 to 125 mm. A grid can be easily removable, such as with a hydraulic lowering device. In yet another embodiment, a rotor of the preshredder can run at between about 10-1000, 20-750, or 50-400 rpm. Material is discharged from the grid at the bottom of the machine and can be carried away by a vibrating conveyor. The vibrating conveyor is often composed of metal and therefore, can accommodate any heated steel components that may be present in the processed material without damage to a system of the invention. The vibrating conveyor can also create a proportionate reduction in fire risk. In another embodiment, a mist spraying system is fitted to the preshredder to reduce friction, thereby improving cutting and reducing fire risk. In this example, the water flow can be controlled to obviate wet finished product and filtration can be used to control dust emission.

In an embodiment, shredded material discharged from the first stage preshedder along the vibrating conveyor can be elevated by means of a conveyor to a second stage preshredder with a grid size having holes of a smaller diameter than the grid fitted on the first stage preshredder. For example, a grid fitted on a second stage preshredder can have holes 10-500 mm in diameter. The grid can also have a hole size that is up to about, about, or greater than about 1, 5, 10, 50, 75, 100, 200, 300, 400, 500, 750, or 1000 mm in diameter. The hole size can be between about 1 to 1000, 5 to 750, 10 to 500, 20 to 250, or 40 to 125 mm. In yet another embodiment, a rotor of the second stage preshredder can run at between about 10-1000, 20-750, or 50-400 rpm.

The second stage preshredder can consist of a higher speed-rotating shaft fitted with knives. The second stage preshredder can produce material of less than about, about, or greater than about 0.5, 1, 5, 10, 20, 30, 50, 75, 100 or 150 mm in size. After shredding the processed material in the second stage preshredder, the material can exit the preshredder and onto another conveyor. In an embodiment, material exits the second stage preshredder onto a metal belt-shaking conveyor. A spraying system can be fitted to the shredder to reduce friction, improving cutting and reducing fire risk. In a further embodiment, water flow is controlled to obviate wet finished product.

The processed material after traveling through at least one preshredder can then be fed onto a conveyor. Preferably, the processed material is a granule of about 1000-1, 500-5, or 100-10 mm diameter or less. In an embodiment, the conveyor is a rubber belt conveyor fitted with eccentric rollers beneath the belt to agitate the material and thus maximize steel removal by means of a magnetic table. The processed material granules can then be transferred to another conveyor, for example, a rubber belt-elevating conveyor. In an embodiment, the magnetic table is an overband magnetic unit suspended from a steel frame above the conveyor to remove any steel material from the processed rubber material.

### Magnetic Separation

After shredding, the processed material can be delivered to a storage hopper that controls the feed rate onto a further conveyor. In an embodiment, the conveyor is a chevroned, rubber belt, elevating conveyor. In an embodiment, the storage hopper is a fabricated steel structure that is flexibly mounted to reduce wear. The storage hopper can include an adjustable gate to control the flow of material.

The processed material can then be fed to a granulator section that comprises initially of a recovery granulator fitted with grids having about 12 mm diameter holes. The holes can also be less than about, about, or greater than about 1, 2, 4, 6, 8, 10, 15, 20, 25, 50, 75, or 100 mm in diameter. The granulator section typically comprises an in-feed hopper and under grid vibrating conveyor to remove the granulated rubber. An overband magnet is mounted over the vibrating tray to remove steel particles. The rubber granules fall from the end of the vibrator directly into the bucket elevator. Filtration takes place in the same manner as on the preshredders.

In an embodiment, the processed material after the granulator section is about 95% metal-free. In another embodiment, the processed material is about 99% metal-free. In yet another embodiment, the processed material contains no metal material. In an embodiment, the processed material after the granulator section is about 95% free of magnetic material. In another embodiment, the processed material is about 99% free of magnetic material. In yet another embodiment, the processed material contains no metal material. In an embodiment, the processed material after the granulator section is about 95% steel-free. In another embodiment, the processed material is about 99% steel-free. In yet another embodiment, the processed material contains no steel material. The percent that the processed material is free of a given type of material can be determined on a mass basis, volume basis, or a combination thereof.

### Additional Processing

In an embodiment, the bucket elevator conveyor elevates material and discharges it into the top of a zigzag system, which is via a rotary valve system. The zigzag conveyor allows any heavy material, such as rocks or metal valves, to be discharged from the bottom. A further processed material can be drawn from the top by means of a pneumatic conveyor system into a cyclone where it is discharged into a screw-elevating conveyor, which feeds the final system. The second stage granulator is a similar machine to the previous granulator, but can be fitted with a grid having about a 5 mm diameter hole size. The grid can have hole sizes that are less than about, about, or greater than about 0.01, 0.1, 0.5, 1, 2, 4, 7.5, 10, 15, or 20 mm in diameter. The second stage granulator can be filtered as the first stage. Material from the granulator, after removal by the metal vibrating conveyor is elevated by means of a screw conveyor and fed to the classifier, wherein any fluff, sterile and light materials is removed by air and transported to the filtering system. The processed material, now rubber granules, are sized by vibrating trays, and the sized products are elevated by screw conveyors feeding permanent rotary magnets to remove any remaining steel. The final rubber products will be passed to the storage system by elevating screw conveyors.

In some embodiments of the invention, a rubber material can be subjected to devulcanization. Devulcanization can include any devulcanization method known to one skilled in the art, including methods that involve chemical or physical processing, or methods described in “Evaluation of Waste Tire Devulcanization Technologies”, CalRecovery Inc., California Integrated Waste Management Publication, December 2004, incorporated herein by reference in its entirety. For example, a devulcanization process can include pyrolyzing the rubber, subjecting the rubber to cryogenic conditions, or subjecting the rubber to ultrasonic waves or microwaves.

### Product Packaging

In some embodiments of the invention, the processed rubber is packaged for delivery to a user. The processed or recycled rubber can be accompanied by a product specification or specification sheet that includes information regarding one or more of the following: particle size, composition, metal content, mechanical properties, source material, source material composition, and source material mechanical properties. The products can be standardized in accordance with any regulatory guidelines, including ISO standards. Packaged products can be inspected for quality control to ensure product quality and/or composition.

### Systems

The various units of the processing system can be provided by a variety of manufacturers, including MTB Recycling, Trept, France and Engineering Services (Brigand) Limited, Brigand, United Kingdom. The system, as described, above can be controlled from two control stations and relay panels, fitted with stop and start buttons and ammeters. The various units can be electrically interlocked to ensure the plant is started in an orderly manner and is closed down in an orderly manner in the event of emergency.

The various units of the system can also include shear feed conveyors, splitter feed conveyors, steel outfeed conveyors, screw feed conveyor, drum separator screw feed conveyors, drum separators, air-cleaning systems, and electrical cabinets. A shear feed conveyor can be used to move materials to a shearing unit. A steel outfeed conveyor can be used to transport steel away from processing unit. Drum separators can be used for magnetic separations, or any other type of separation.

The systems described herein can include an air-cleaning system for removing materials from the air. The air-cleaning system can reduce the amount of particulates in the air and/or reduce the chance of spontaneous combustion or other hazardous conditions.

In some embodiments of the invention, the processing units and be cleaned between groups or batches of material such that the products from each group or batch are substantially free of products from another group or batch. Cleaning between groups can improve product quality and reduce the chance of undesired components being present in the product. Cleaning can include washing, gas-blowing, manual cleaning, chemical washing, air-cleaning, replacement of parts, substitution of parts, switching of processing units, or any combination thereof.

### Example 1

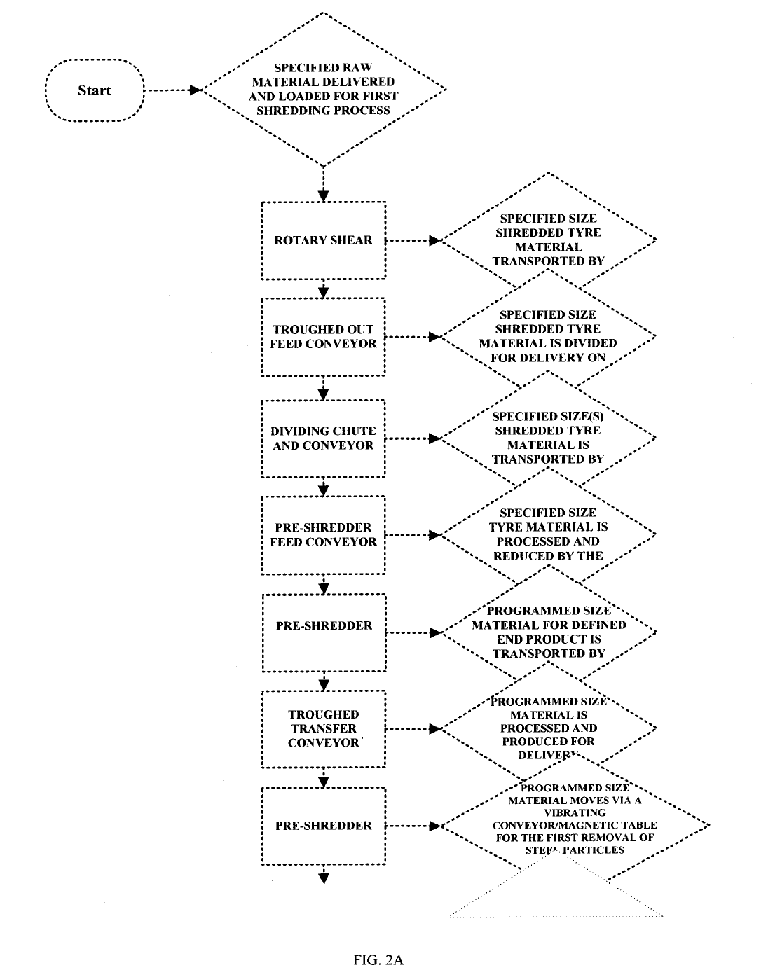

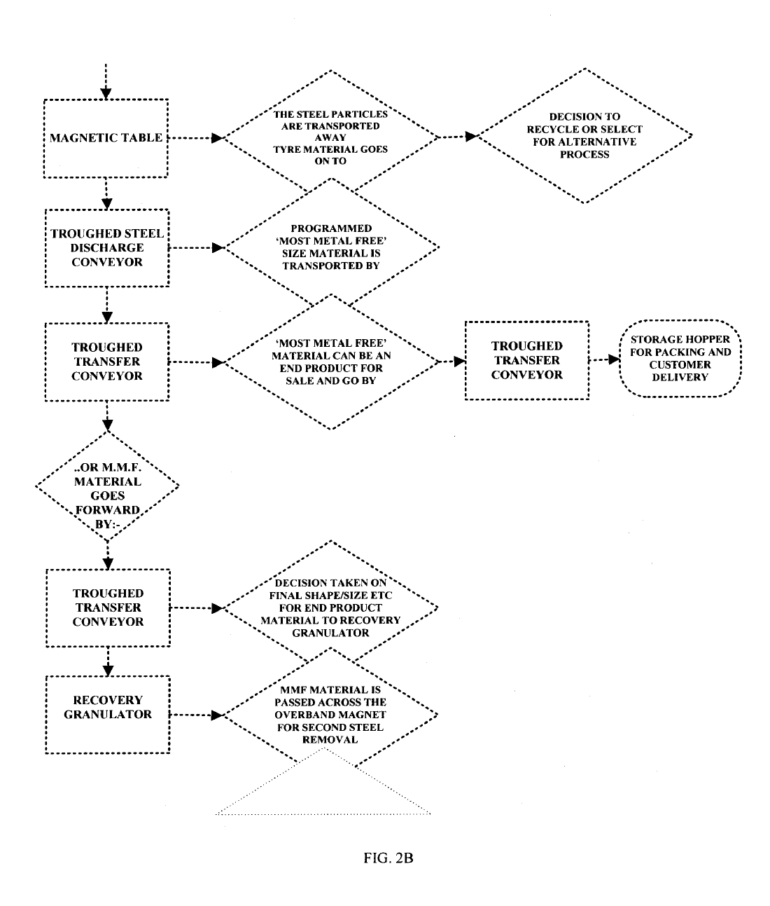

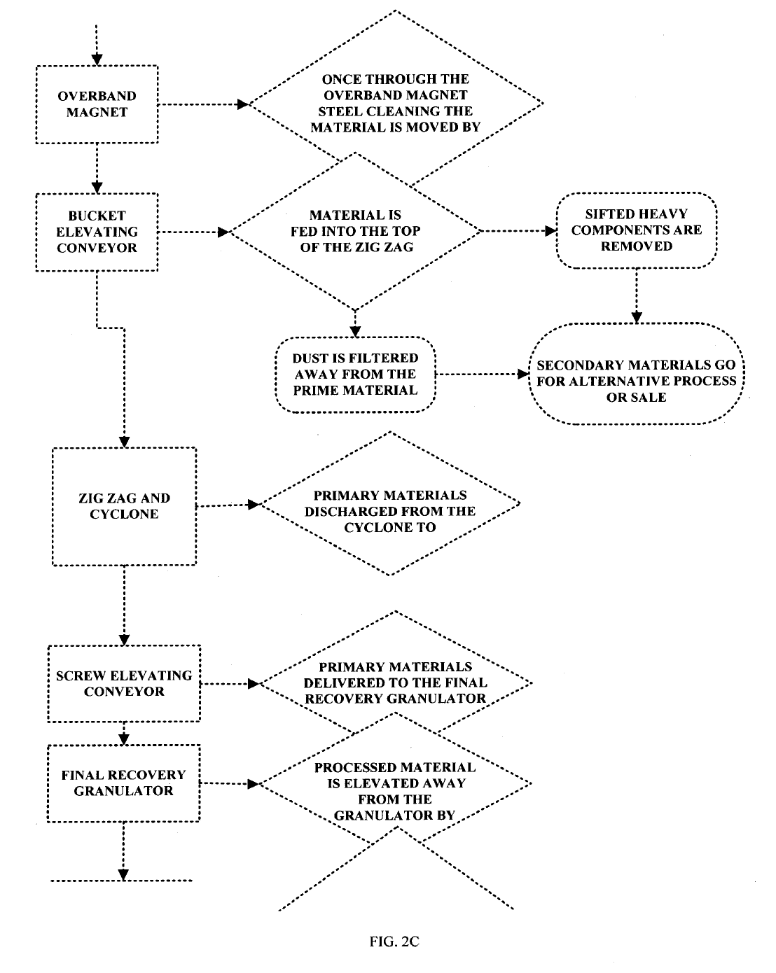

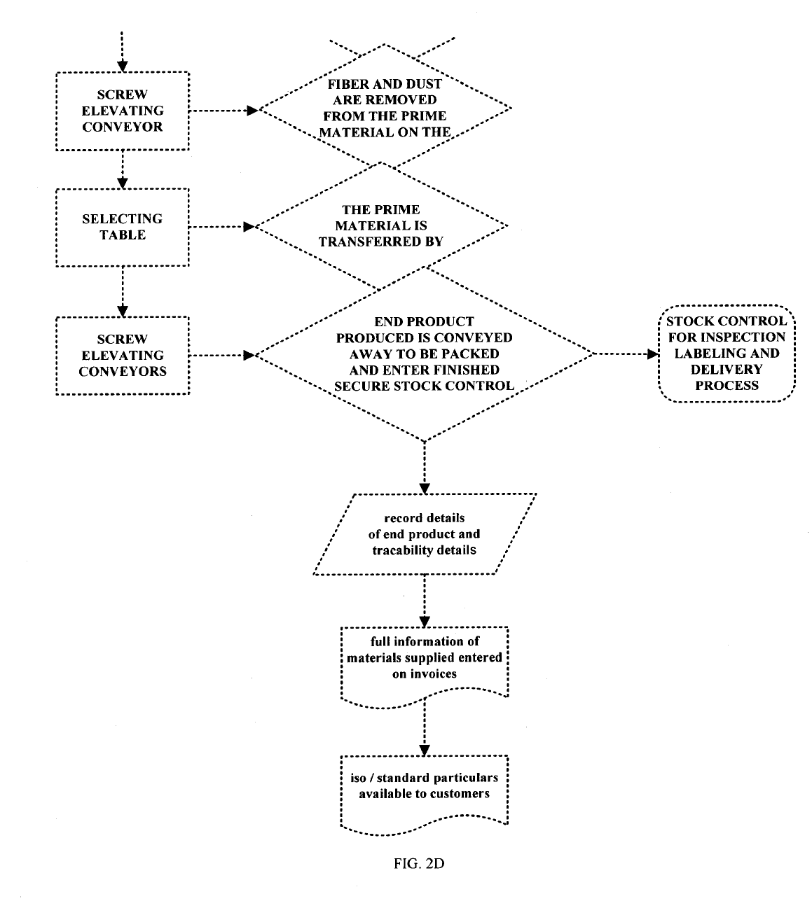

FIGS. 2A, 2B, 2C, and 2D demonstrate an exemplary system as described herein. After raw material, such as waste or redundant rubber, is selected by a process, such as a process of the invention carried out by trained personnel, the specified raw material is delivered and loaded for a first shredding process. A rotary shear can initiate the shredding process by specified size of material, such as a tire. The shredded material is then transported by a troughed out feed conveyor and divided by a dividing chute and conveyor, from which the divided material is transported by a preshredder feed conveyor by specified shred sizes. The specified size shredded processed rubber material is reduced by a first preshredder wherein a size of shredded material can be chosen or programmed by a user. The process material is then transported by a troughed transfer conveyor to another preshredder that further shreds the rubber material to a programmed size, which is then moved by a vibrating conveyor with a magnetic table for the removal of steel particles.

As demonstrated in FIGS. 2A, 2B, 2C, and 2D, after the magnetic table, the steel particles removed from the rubber can then be transported by a troughed steel discharge conveyor to an area where a decision to recycle or select the metal for alternative process can be made. The “most metal free” processed rubber material can be an end product for sale and go by another conveyor to a storage hopper for packing and customer delivery.

As shown in FIGS. 2A, 2B, 2C, and 2D, the processed rubber material can also go forward by a conveyor from the process as described or from a storage hopper. Personnel can then make a decision on the final shape or size of the end product material sent to the recovery granulator. The shape or size can be filtered by a grid with used defined specifications. Once the product goes through the recovery granulator, the processed material can pass through an overband magnet for the removal of any additional metal in the material. Once through the overband magnet, the bucket conveyor elevates the processed material to the entrance hopper for a Zigzag conveyor as shown in FIGS. 2A, 2B, 2C, and 2D.

The material is pneumatically fed from the integral hopper into the Zigzag at the top. Heavy components continue down the Zigzag for collection and removal for further process or alternative recycling. Rubber granules from the Zigzag are separated in the cyclone and discharged to a screw conveyor to feed into the recovery granulator. Dust removal can be controlled through the Top Hat of the cyclone by filtration. A bin or conveyor for further processes or alternative recycling can remove heavy components.

Programmed material is discharged from the cyclone to the second series granulator by a screw elevator. The screw elevator can deliver the programmed material to the final recovery granulator for granulation to the specified end product dimension regulated by the appropriate grid sizes installed in the granulator according to the end product required.

Programmed material is elevated away from the granulator and discharged onto the selecting table using the screw elevator conveyor. Fiber and dust are removed from the product on the selecting table and the processed is finally sized using vibrating sieves pre-set to the end product specification. At the selecting table, screw elevator conveyors to pass over the magnetic separator for a final steel check and removal transfer the material.

End product produced and finally checked through the magnetic separator is conveyed away from the separator by a screw elevating conveyor to be packed and enter finished stock control.

Unsuitable material for specified end product use is removed by the separator and is transported away by bin or conveyor for further process or alternative use.

After the end product has been processed by the exemplary method, trained personnel or computer systems can perform stock control for inspection labeling and delivery processes. The details of end products and traceability details can be recorded. Full information can be provided to a customer, for example, on invoices. In addition, the systems also provide ISO standard particulars to customers.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A process for recycling waste rubber material for a desired end product comprising:
a. training personnel for identification of the composition of waste rubber material;
b. identifying the composition of the waste rubber material, wherein said identifying is carried out by said personnel; and
c. separating said waste rubber material based upon a desired end product of manufacture, thereby generating a desired recycled rubber;
d. delivering said recycled rubber to a user.

2. A process for recycling rubber comprising:
a. assessing waste rubber materials according to the composition of the materials;
b. selecting at least one of said waste rubber materials for processing of a certain composition as assessed in step a), wherein the material is selected for the manufacture of an object;
c. separating the selected waste rubber material(s) of step b); and
d. processing said separated waste rubber material(s) into material for said manufacture of said object.

3. A system for recycling rubber comprising:
a. at least one selection system, wherein said selection system comprises criteria for rubber granules for the manufacture of a end product selected by a user;
b. at least one shredding device for shredding waste rubber material, wherein said at least one shredding device is fitted with a grid that determines the size of the shredded material;
c. at least one conveyor, wherein said at least one conveyor transports shredded material through the system; and
d. at least one metal remover, wherein said at least one metal remover removes metal from rubber of the shredded material,
wherein the system generates rubber granules of a predetermined size and quality based upon said end product selected by a user.

4. The process of claim 1, wherein the waste rubber material is tagged with identifying information.

5. The process of claim 1, wherein the separating step comprises separating based on magnetic properties.

6. The process of claim 1, wherein the separating step comprises separating based on density.

7. The process of claim 1, wherein the recycled rubber is accompanied by a specification sheet that contains information regarding the recycled rubber.

8. The process of claim 2, wherein the assessing waste rubber materials includes analyzing the composition of the waste rubber materials.

9. The process of claim 2, wherein the separating step includes removing toxic materials.

10. The process of claim 2, wherein the separating step includes removing metals.

11. The system of claim 3, wherein the criteria for rubber granules includes granules of between about 4 to 5 mm.

12. The system of claim 3, wherein the rubber granules are about 95% metal-free.

13. The system of claim 3, wherein the rubber granules are about 99% metal-free.
